(19) United States
(12) Patent Application Publication
(10) Pub. No.: US 2011/0110085 A1
(43) Pub. Date: May 12, 2011

(54) Light Emitting Diode Module

(75) Inventors: Jerold Alan Tickner, Newnan, GA (US); Chun Wah Chan, Peachtree City, GA (US)

(73) Assignee: Cooper Technologies Company, Houston, TX (US)

(21) Appl. No.: 12/617,127

(22) Filed: Nov. 12, 2009

(51) Int. Cl. F21S 4/00

(52) U.S. Cl. 362/249.02

(57) ABSTRACT

A light fixture includes multiple light emitting diode (“LED”) modules. Each LED module includes a substrate on which one or more LED's are disposed. The LED modules can interface with one another in a variety of different configurations including an end-to-end configuration in which adjacent ends of the LED modules interface with one another. When adjacent LED modules interface with one another, there is a substantially continuous array of LED's across the LED modules. For example, one or more rows or alignment patterns of the LED's may continue, substantially uninterrupted, within and across the LED modules. Electrical connectors or other means for powering the LED modules are disposed remote from the interfacing locations. For example, electrical connectors may couple to side ends of the LED modules, away from interfacing ends of the LED modules. Thus, the electrical connectors do not impact the continuity of light across adjacent LED modules.

### TECHNICAL FIELD

The invention relates generally to light emitting diodes (“LED's”) and more particularly to LED modules that interface with one another in a variety of different configurations to provide a substantially continuous array of LED's across the LED modules.

### BACKGROUND

The use of LED's in place of conventional incandescent, fluorescent, and neon lamps has a number of advantages. LED's tend to be less expensive and longer lasting than conventional incandescent, fluorescent, and neon lamps. In addition, LED's generally can output more light per watt of electricity than incandescent, fluorescent, and neon lamps.

Linear light fixtures are popular for a variety of different residential and commercial lighting applications, including cabinet lighting, shelf lighting, cove lighting, and signage. Cove lighting is a form of indirect lighting in which lamps are built into ledges, recesses, or valences in a ceiling or high on the walls of a room. Linear light fixtures can provide primary lighting in an environment or serve as aesthetic accents or designs that complement other lighting sources.

Conventional linear LED light fixtures include modules or strips of LED's that are mechanically and electrically coupled to one another in an end-to-end relationship. FIG. 1 illustrates two conventional LED strips 105 and 106 that could be used in such a light fixture. Each strip 105, 106 includes multiple LED's 108. A second end 105b of strip 105 is electrically and mechanically coupled to a first end 106a of strip 106 via a connector 110. Adjacent pairs of LED's 108a-108d on strip 105 are spaced apart from one another by a distance X. Adjacent pairs of LED's 108e-108h on strip 106 are spaced apart from one another by the same distance X.

Adjacent LED's 108d and 108e across the LED strips 105 and 106 are spaced apart from one another by a distance Y. The distance Y is significantly larger than the distance X. This space between the LED's 108d and 108e causes the light output by the LED strips 105 and 106 to be discontinuous. In particular, the light output by the LED strips 105 and 106 includes an undesirable break or shadow that corresponds to the space between the LED strips 105 and 106.

Therefore, a need exists in the art for an improved linear LED light fixture. In particular, a need exists in the art for LED modules that interface with one another in a way that produces continuous light output across the LED modules. A further need exists in the art for such light output to be devoid of undesirable shadows and breaks.

### SUMMARY

The invention provides an improved linear LED light fixture. In particular, the invention provides LED modules that interface with one another in a variety of different configurations to provide a substantially continuous array of LED's across the LED modules. This continuity in the array of the LED's enables the LED modules to output continuous light across the LED modules, without any undesirable shadows or breaks.

Each LED module includes a substrate on which one or more LED's are disposed. The LED modules can interface with one another in a substantially continuous, end-to-end relationship. For example, each substrate can include a notch or protrusion in which a corresponding protrusion or notch of an adjacent substrate may be disposed. When adjacent LED modules interface with one another, there is a substantially continuous array of LED's across the LED modules. For example, one or more rows or patterns of LED's may continue, substantially uninterrupted, within and across the LED modules.

The LED modules may be powered using electrical connectors, which electrically couple together adjacent LED modules. Each electrical connector can be coupled to its associated LED modules at locations other than the ends at which the LED modules interface with one another. Thus, unlike with the conventional LED strips 105 and 106 depicted in FIG. 1, the electrical connectors do not impact the continuity of light across adjacent LED modules. In addition to, or instead of, electrical connectors, powered surfaces, such as rails and tracks, may power the LED modules. For example, the LED modules may be coupled to the powered surfaces.

A light fixture may include multiple LED modules mounted to a surface. For example, the LED modules may be removably coupled to the surface using screws, nails, or other fastening devices. The light fixture may be a linear or non-linear light fixture used in residential, commercial, or other lighting applications.

These and other aspects, features and embodiments of the invention will become apparent to a person of ordinary skill in the art upon consideration of the following detailed description of illustrated embodiments exemplifying the best mode for carrying out the invention as presently perceived.

### BRIEF DESCRIPTION OF THE DRAWINGS

For a more complete understanding of the present invention and the advantages thereof, reference is now made to the following description, in conjunction with the accompanying figures briefly described as follows.

FIG. 1 is a block diagram that illustrates conventional LED strips of a linear light fixture.

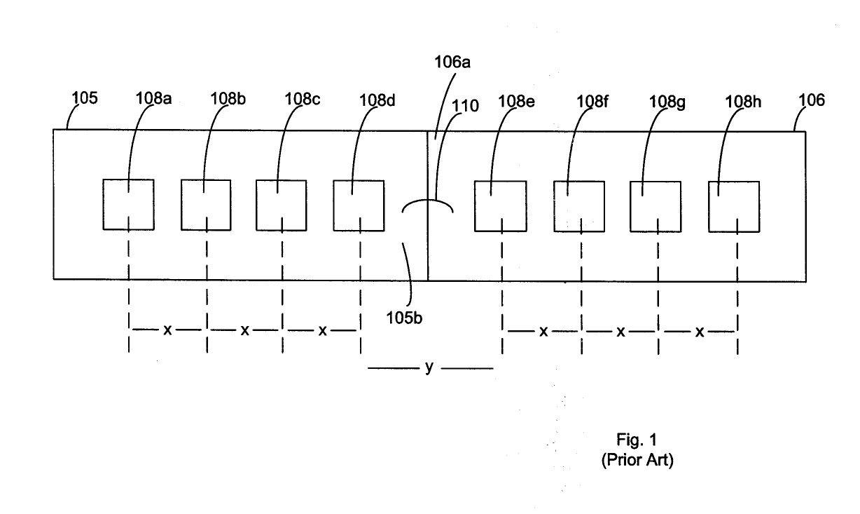

FIG. 2 is a top elevational view of an LED assembly, which includes linear LED modules, in accordance with certain exemplary embodiments.

FIG. 3 is a side elevational view of one of the linear LED modules depicted in FIG. 2, in accordance with certain exemplary embodiments.

FIG. 4 is a top elevational view of an LED assembly, which includes multiple groupings of the linear LED modules depicted in FIG. 2, in accordance with certain exemplary embodiments.

FIG. 5 is a top elevational view of an LED assembly, which includes LED modules arranged in an “L” shape, in accordance with certain exemplary embodiments.

FIG. 6 is a top elevational view of an LED assembly of linear LED modules, in accordance with certain alternative exemplary embodiments.

FIG. 7 is an elevational bottom view of a light fixture that includes the linear LED modules depicted in FIG. 2, in accordance with certain exemplary embodiments.

### DETAILED DESCRIPTION OF EXEMPLARY EMBODIMENTS

The invention is directed to LED modules that interface with one another in a variety of different configurations to provide a substantially continuous array of LED's across the LED modules. This continuity in the array of the LED's enables the LED modules to output continuous light across the LED modules, without any undesirable shadows or breaks. The LED modules can provide light in any of a number of different residential and commercial lighting applications. For example, the LED modules can be installed on any surface to provide cabinet lighting, shelf lighting, cove lighting, and signage.

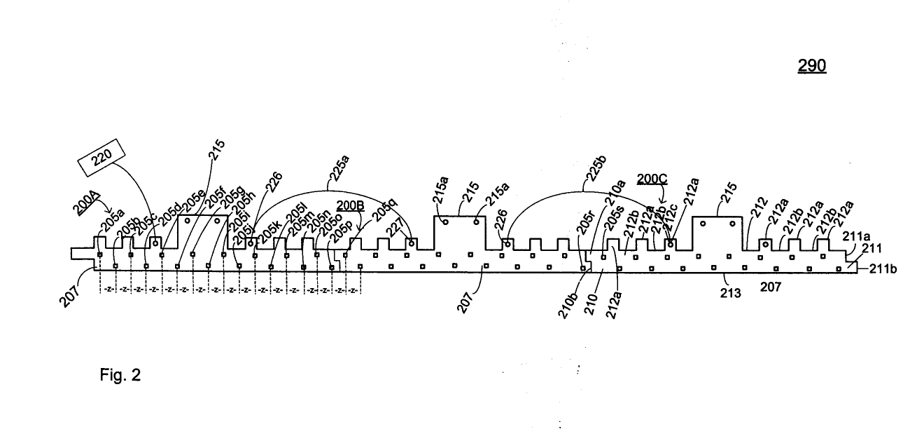

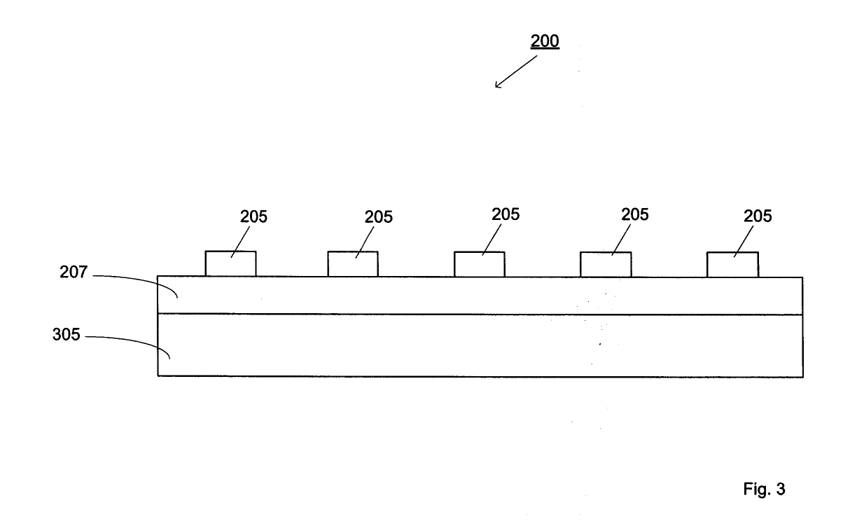

Turning now to the drawings, in which like numerals indicate like elements throughout the figures, exemplary embodiments of the invention are described in detail. FIG. 2 is a top elevational view of an LED assembly 290, which includes LED modules 200, in accordance with certain exemplary embodiments. FIG. 3 is a side elevational view of one of the LED modules 200, in accordance with certain exemplary embodiments. With reference to FIGS. 2 and 3, each LED module 200 is configured to create artificial light or illumination via multiple LED's 205. For purposes of this application, each LED 205 may be a single LED die or may be an LED package having one or more LED dies on the package. In certain exemplary embodiments, the number of dies on each LED package ranges from 1-312. For example, each LED package may include 2 dies.

Each LED module 200 includes at least one substrate 207 to which the LED's 205 are coupled. Each substrate 207 includes one or more sheets of ceramic, metal, laminate, circuit board, flame retardant (FR) board, mylar, or other material. Although depicted in FIGS. 2 and 3 as having a substantially rectangular shape, a person of ordinary skill in the art having the benefit of the present disclosure will recognize that the substrate 207 can have any linear or non-linear shape. Each LED 205 is attached to its respective substrate 207 by a solder joint, a plug, an epoxy or bonding line, or other suitable provision for mounting an electrical/optical device on a surface. Each LED 205 includes semi-conductive material that is treated to create a positive-negative (p-n) junction. When the LED's 205 are electrically coupled to a power source 220, such as a driver, current flows from the positive side to the negative side of each junction, causing charge carriers to release energy in the form of incoherent light.

The wavelength or color of the emitted light depends on the materials used to make each LED 205. For example, a blue or ultraviolet LED typically includes gallium nitride (GaN) or indium gallium nitride (InGaN), a red LED typically includes aluminum gallium arsenide (AlGaAs), and a green LED typically includes aluminum gallium phosphide (AlGaP). Each of the LED's 205 is capable of being configured to produce the same or a distinct color of light. In certain exemplary embodiments, the LED's 205 include one or more white LED's and one or more non-white LED's, such as red, yellow, amber, green, or blue LED's, for adjusting the color temperature output of the light emitted from the LED modules 200. A yellow or multi-chromatic phosphor may coat or otherwise be used in a blue or ultraviolet LED 205 to create blue and red-shifted light that essentially matches blackbody radiation. The emitted light approximates or emulates “white,” light to a human observer. In certain exemplary embodiments, the emitted light includes substantially white light that seems slightly blue, green, red, yellow, orange, or some other color or tint. In certain exemplary embodiments, the light emitted from the LED's 205 has a color temperature between 2500 and 6000 degrees Kelvin.

In certain exemplary embodiments, an optically transmissive or clear material (not shown) encapsulates at least some of the LED's 205, either individually or collectively. This encapsulating material provides environmental protection while transmitting light from the LED's 205. For example, the encapsulating material can include a conformal coating, a silicone gel, a cured/curable polymer, an adhesive, or some other material known to a person of ordinary skill in the art having the benefit of the present disclosure. In certain exemplary embodiments, phosphors are coated onto or dispersed in the encapsulating material for creating white light.

Each LED module 200 includes one or more rows of LED's 205. The term “row” is used herein to refer to an arrangement or a configuration whereby one or more LED's 205 are disposed approximately in or along a line. LED's 205 in a row are not necessarily in perfect alignment with one another. For example, one or more LED's 205 in a row might be slightly out of perfect alignment due to manufacturing tolerances or assembly deviations. In addition, LED's 205 in a row might be purposely staggered in a non-linear or non-continuous arrangement. Each row extends along a longitudinal axis of the LED module 200.

Although depicted in FIG. 2 as having two staggered rows of LED's 205, a person of ordinary skill in the art having the benefit of the present disclosure will recognize that the LED's 205 can be arranged in any number of different rows, shapes, and configurations without departing from the spirit and scope of the invention. For example, the LED's 205 can be arranged in four different rows, with each row comprising LED's 205 of a different color. In certain exemplary embodiments, each row and/or each LED 205 is separately controlled by the driver so that each row can independently be turned on and off or otherwise reconfigured.

In the exemplary embodiment depicted in FIG. 2, each LED module 200 includes 16 LED's 205. The number of LED's 205 on each LED module 200 may vary depending on the size of the LED module 200, the size of the LED's 205, the amount of illumination required from the LED module 200, and/or other factors. For example, a larger LED module 200 with small LED's 205 may include more LED's 205 than a smaller LED module 200 with large LED's 205.

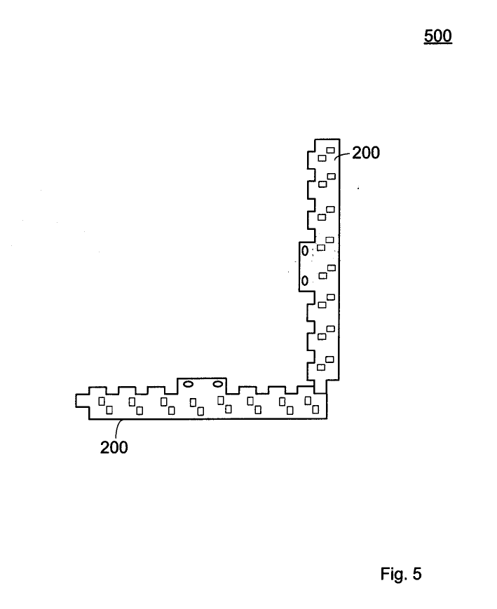

Adjacent pairs of LED's 205 on each LED module 200 are spaced apart from one another by a distance Z. Adjacent LED's 205p and 205q across LED modules 200A and 200B are spaced apart from one another by the same or substantially the same distance Z. Similarly, adjacent LED's 205r and 205s across LED modules 200B and 200C are spaced apart from one another by the same or substantially the same distance Z. Thus, all adjacent pairs of LED's 205 across the LED modules 200 are spaced apart by the same or substantially the same distance Z. This equal or substantially equal spacing across the LED modules 200 provides a continuous array of LED's 205 across the LED modules 200. Because the array is continuous, light output from the LED modules 200 is continuous, without any undesirable breaks or shadows. As described below with reference to FIG. 5, in certain alternative exemplary embodiments, the LED modules 200 can be configured to provide a substantially continuous array of LED's 205 without each adjacent pair of LED's 205 being equally spaced apart.

Ends 210 and 211 of each LED module 200 have profiles that enable adjacent pairs of the LED modules 200 to interface with one another. For example, in the embodiment depicted in FIG. 2, a first side end 210 of each LED module 200 includes a protrusion 210a that is sized and configured to be at least partially disposed adjacent a corresponding notch 211a in a second side end 211 of an adjacent LED module 200. Similarly, the second side end 211 of each LED module 200 includes a protrusion 211b that is sized and configured to be at least partially disposed adjacent a corresponding notch 210b in the first side end 210 of an adjacent LED module 200. Although depicted in FIG. 2 as substantially rectangular, the notches 210b and 211a and protrusions 210a and 211b in the LED modules 200 can have any size or shape. In addition, although depicted in FIG. 2 in an end-to-end relationship, adjacent LED modules 200 may interface one another in other configurations. For example, LED modules 200B and 200C may be arranged such that the protrusion 210a of LED module 200C rests at least partially adjacent the notch 211a or protrusion 211b of LED module B and a longitudinal axis of LED module 200C is disposed substantially perpendicular to a longitudinal axis of LED module 200B, substantially as described below with reference to FIG. 5.

A person of ordinary skill in the art having the benefit of the present disclosure will recognize that any of a number of other configurations of the adjacent ends 210 and 211 may be used to interface adjacent LED modules 200. For example, in certain alternative exemplary embodiments, the end of one LED module 200 can include multiple protrusions that are sized and configured to be disposed within corresponding notches in an adjacent LED module 200. Alternatively, in certain exemplary embodiments, one or both of the ends of each LED module 200 may have a substantially flat edge with not notches or protrusions. In certain alternative exemplary embodiments, only one of the ends 210 and 211 of each LED module 200 may have a profile that enables the LED module 200 to interface with another LED module 200. In certain exemplary embodiments, a top side end 212 of each LED module 200 includes one or more protrusions 212a and notches 212b sized and configured to engage one or more of the notches 210b and 211a and protrusions 210a and 211b in the side ends 210 and 211 of another, adjacent LED module 200.

In certain exemplary embodiments adjacent LED modules 200 are electrically coupled to one another via a connector 225. Each connector 225 can include one or more electrical wires, plugs, sockets, and/or other components that enable electrical transmission between electrical devices. In these exemplary embodiments, each connector 225 includes a first end 226 that is coupled to a protrusion 212a in a top side end 212 of one LED module 200 and a second end 227 that is coupled to a protrusion 212a in a top side end 212 of an adjacent LED module 200.

Because the connectors 225 extend from top side ends 212 of the LED modules 200, and not from interfacing side ends 210 and 211 of the LED modules 200, the LED modules 200 can engage one another without any significant gaps between the LED modules 200 or the pattern of LED's 205 on the LED modules 200. Thus, the LED modules 200 can provide a substantially continuous array or pattern of LED's 205 across the LED modules 200. A person of ordinary skill in the art having the benefit of the present disclosure will recognize that, in alternative exemplary embodiments, each connector 225 may be coupled to its corresponding LED modules 200 at other locations. For example, one or more of the connectors 225 can be connected to a bottom end 213 of an LED module 200. In certain alternative exemplary embodiments, the LED modules 200 can be mounted to a powered rail, track, or other device, which powers the LED modules 200 without using any connectors 225.

Each LED module 200 is configured to be mounted to a surface (not shown) to illuminate an environment associated with the surface. For example, each LED module 200 may be mounted to, or within, a wall, counter, cabinet, sign, light fixture, or other surface. Each LED module 200 may be mounted to its respective surface using solder, braze, welds, glue, epoxy, rivets, clamps, screws, nails, or other fastening means known to a person of ordinary skill in the art having the benefit of the present disclosure. In certain exemplary embodiments, one or more of the LED modules 200 are removably mounted to their corresponding surfaces to enable efficient repair, replacement, and/or reconfiguration of the LED module(s) 200. For example, each LED module 200 may be removably mounted to its corresponding surface via one or more screws extending through openings 215a defined in protrusions 215 in the top side end 212 of the LED module 200.

To remove one of the LED modules 200, a person can simply disconnect the connector(s) 225 associated with the LED module 200 and unscrew the screws associated with the LED module 200. In certain exemplary embodiments, once the LED module 200 is removed, the remaining LED modules 200 may be electrically coupled to one another using one or more of the disconnected connectors 215. For example, if a person removes LED module 200B, he can electrically couple LED module 200A to LED module 200C by connecting the connector 225a to the LED module 200C in place of the connector 225b.

The level of light a typical LED 205 outputs depends, in part, upon the amount of electrical current supplied to the LED 205 and upon the operating temperature of the LED 205. Thus, the intensity of light emitted by an LED 205 changes when electrical current is constant and the LED's 205 temperature varies or when electrical current varies and temperature remains constant, with all other things being equal. Operating temperature also impacts the usable lifetime of most LED's 205.

As a byproduct of converting electricity into light, LED's 205 generate a substantial amount of heat that raises the operating temperature of the LED's 205 if allowed to accumulate on the LED's 205, resulting in efficiency degradation and premature failure. Each LED module 200 is configured to manage heat output by its LED's 205. Specifically, each LED module 200 includes a conductive member 305 that is coupled to the substrate 207 and assists in dissipating heat generated by the LED's 205. Specifically, the member 305 acts as a heat sink for the LED's 205. The member 305 receives heat conducted from the LED's 205 through the substrate 207 and transfers the conducted heat to the surrounding environment (typically air) via convection.

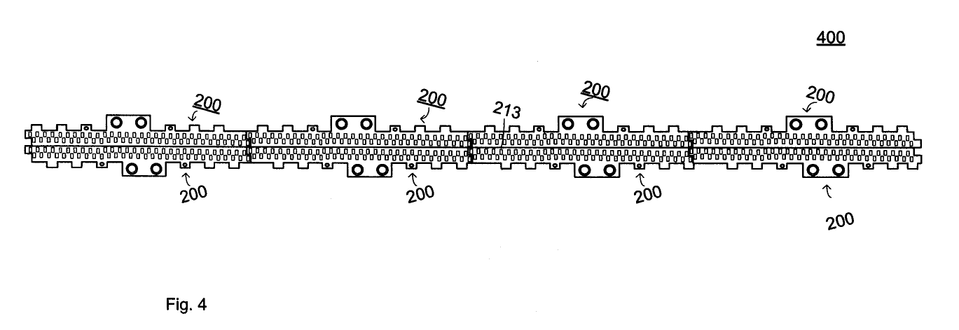

FIG. 4 is a top elevational view of an LED assembly 400, which includes multiple groupings of the LED modules 200 depicted in FIG. 2, in accordance with certain exemplary embodiments. In addition to the interfaces at the side ends 210 and 211 of the LED modules, interfaces exist at bottom ends 213 of the LED modules 200. Specifically, a bottom end 213 of each LED module 200 engages a bottom end 213 of another, adjacent LED module 200. By interfacing the bottom ends 213, two adjacent LED modules 200 having a particular width can effectively constitute a single, continuous LED source that has a width that is twice the width of a single LED module.

The options for configuring and arranging multiple LED modules 200 with respect to one another are infinite. For example, multiple LED modules 200 can be arranged to form any of a variety of numbers, letters, shapes, etc. For example, FIG. 5 is a top elevational view of an LED assembly 500, which includes LED modules 200 arranged in an “L” shape, in accordance with certain exemplary embodiments. Thus, the LED modules 200 provide a flexible and efficient lighting option for both new lighting application installations and retro-fit applications. For example, in certain exemplary embodiments, LED modules 200 may be arranged on, and secured to, a member to be retro-fit into an existing light fixture.

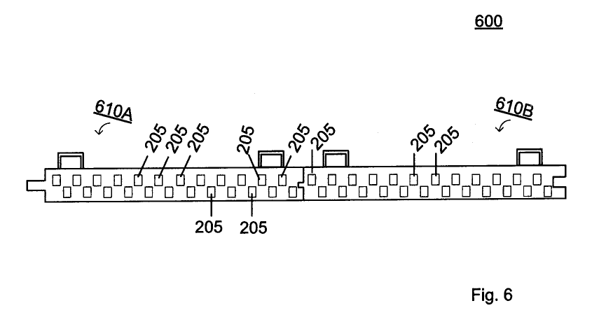

FIG. 6 is a top elevational view of an LED assembly 600, which includes linear LED modules 610A and 610B, in accordance with certain alternative exemplary embodiments. Like the LED modules 200A-200C depicted in FIG. 2, each of the LED modules 610 includes one or more rows of LED's 205. Unlike the LED's 205 in the LED modules 200A-200C, the LED's 205 in the LED modules 610A and 610B are not equally spaced apart. Instead, the LED's 205 in the LED modules 610A and 610B are arranged in a pattern in which adjacent pairs of LED's 205 have different spacings. In certain exemplary embodiments, the pattern is predictable and repeated on the same LED module 610. In addition, or in the alternative, because the LED modules 610 interface one another without any gaps between the LED modules 610, the pattern may be repeated continuously across adjacent modules 610A and 610B.

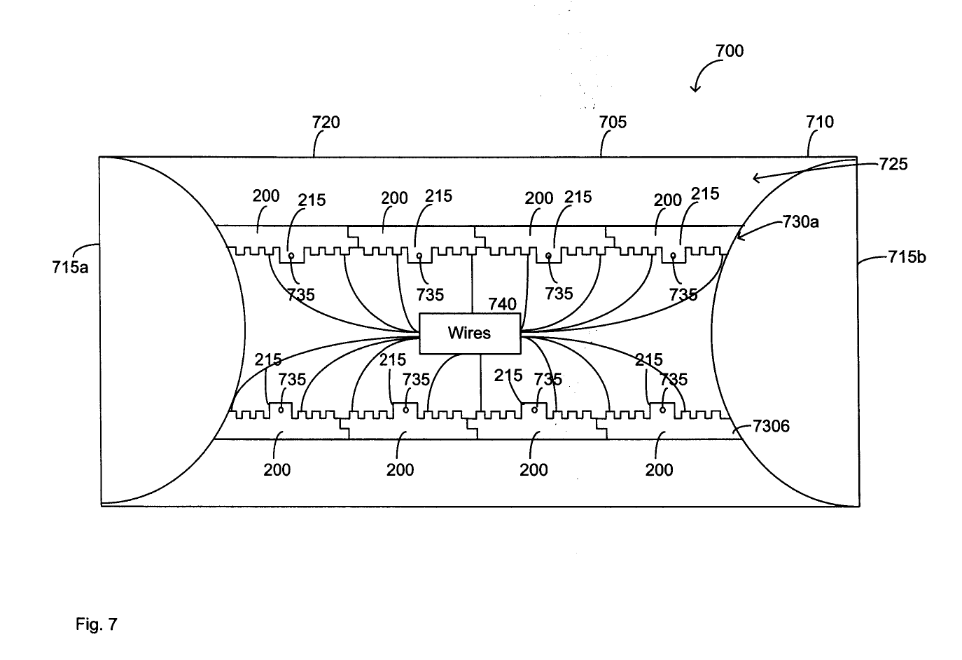

FIG. 7 is an elevational bottom view of a light fixture 700 that includes the linear LED modules 200 depicted in FIG. 2, in accordance with certain exemplary embodiments. The light fixture 700 includes a troffer 705 that includes a frame 710 having side ends 715a and 715b and a top 720 extending between the side ends 715a and 715b. In certain exemplary embodiments, each side end 715a and 715b extends from the top 720 at a substantially orthogonal angle. The side ends 715a and 715b and top 720 define an interior region 725.

Rows 730a and 730b of LED modules 200 extend within the interior region 725, substantially between the side ends 715a and 715b. Each LED module 200 is mounted to the top 720 via solder, braze, welds, glue, epoxy, rivets, clamps, screws, nails, or other fastening means known to a person of ordinary skill in the art having the benefit of the present disclosure. In certain exemplary embodiments, one or more of the LED modules 200 are removably mounted to the top 720 to enable efficient repair, replacement, and/or reconfiguration of the LED module(s) 200. For example, each LED module 200 may be removably mounted to the top 720 via one or more screws 735 extending through protrusions 215 of each LED module 200, substantially as described above. The LED modules 200 are electrically coupled to one another and to a power source (not shown) via one or more wires 740, substantially as described above.

The LED fixture 700 outputs light from the LED modules 200 into an environment associated with the LED fixture 700. Although FIG. 7 depicts a troffer LED fixture 700, a person of ordinary skill in the art having the benefit of the present disclosure will recognize that the LED modules 200 may be used in any other light fixture. For example, the LED modules 200 may be used in light fixtures for indoor and/or outdoor, commercial and/or residential applications.

Although specific embodiments of the invention have been described above in detail, the description is merely for purposes of illustration. It should be appreciated, therefore, that many aspects of the invention were described above by way of example only and are not intended as required or essential elements of the invention unless explicitly stated otherwise. Various modifications of, and equivalent steps corresponding to, the disclosed aspects of the exemplary embodiments, in addition to those described above, can be made by a person of ordinary skill in the art, having the benefit of this disclosure, without departing from the spirit and scope of the invention defined in the following claims, the scope of which is to be accorded the broadest interpretation so as to encompass such modifications and equivalent structures.

What is claimed is:

1. A light emitting diode (“LED”) assembly, comprising:
a first LED module comprising:
a first substrate having a first end and a second end; and
a first plurality of LED's coupled to the first substrate; and
a second LED module comprising:
a second substrate having a first end and a second end; and
a second plurality of LED's coupled to the second substrate,
wherein the second end of the first LED module and the first end of the second LED module have profiles such that, when the second end of the first LED module interfaces with the first end of the second LED module, there is a substantially continuous, uninterrupted array of LED's across the first and second LED modules, the array comprising at least a portion of each of the first plurality of LED's and the second plurality of LED's.

2. The LED assembly of claim 1, further comprising a connector electrically coupling the first LED module to the second LED module, the connector being coupled to each of the first LED module and the second LED module at a location other than the first and second ends of the LED module.

3. The LED assembly of claim 1, wherein the first plurality of LED's are arranged in at least a first row, and the second plurality of LED's are arranged in at least a second row, the first and second rows being substantially aligned with one another when the second end of the first LED module interfaces with the first end of the second LED module.

4. The LED assembly of claim 1, wherein an alignment pattern of the first plurality of LED's on the first LED module continues substantially uninterrupted across the first LED module and the second LED module when the second end of the first LED module interfaces with the first end of the second LED module.

5. The LED assembly of claim 1, wherein a longitudinal distance between (a) a first LED of the first plurality of LED's, that is longitudinally disposed closest to the second end of the first LED module, and (b) a second LED of the first plurality of LED's, that is longitudinally disposed second-closest to the second end of the first LED module, substantially equals a longitudinal distance between the first LED and an LED of the second plurality of LED's that is longitudinally disposed closets to the first end of the second LED module.

6. The LED assembly of claim 1, wherein the second end of the first module comprises a protrusion that is at least partially disposed adjacent a corresponding notch in the first end of the second module when the second end of the first LED module interfaces with the first end of the second LED module.

7. The LED assembly of claim 1, wherein the first end of the second module comprises a protrusion that is at least partially disposed adjacent a corresponding notch in the second end of the first module when the second end of the first LED module interfaces with the first end of the second LED module.

8. A light emitting diode (“LED”) assembly, comprising:
a first LED module comprising:
a first substrate having a first end and a second end; and
a first plurality of LED's coupled to the first substrate;
a second LED module comprising:
a second substrate having a first end and a second end; and
a second plurality of LED's coupled to the second substrate; and
a connector electrically coupling the first LED module to the second LED module, the connector being coupled to each of the first LED module and the second LED module at a location other than the first and second ends of the LED module,
wherein the second end of the first LED module and the first end of the second LED module have profiles such that, when the second end of the first LED module interfaces with the first end of the second LED module, there is a substantially continuous, uninterrupted array of LED's across the first and second LED modules, the array comprising at least a portion of each of the first plurality of LED's and the second plurality of LED's.

9. The LED assembly of claim 1, wherein each of the first LED module and the second LED module further comprises a side end, the connector being coupled to each side end.

10. A light fixture, comprising:
a surface; and
a plurality of LED modules removably coupled to the surface, each LED module comprising:
a substrate having a first end and a second end; and
a plurality of LED's coupled to the first substrate,
wherein adjacent ones of the LED modules interface with one another such that there is a substantially continuous, uninterrupted array of the LED's across the LED modules.

11. The light fixture of claim 10, further comprising at least one connector, each connector being associated with a pair of adjacent ones of the LED modules, each connector being coupled to each of the corresponding adjacent LED modules at a location other than the first and second ends of the LED module.

12. The light fixture of claim 10, wherein the LED's are arranged in at least one continuous row that extends across the LED modules.

13. The light fixture of claim 10, wherein an alignment pattern of the LED's continues substantially uninterrupted within and across the LED modules.

14. The light fixture of claim 10, wherein a longitudinal distance between adjacent ones of the LED's is substantially equal within and across the LED modules.

15. The light fixture of claim 10, wherein the surface provides power to the LED modules.
